(19) United States
(12) Patent Application Publication
(10) Pub. No.: US 2011/0013511 A1
(43) Pub. Date: Jan. 20, 2011

(54) End-to-end pattern classification based congestion detection using SVM

(76) Inventors: Dekai LI, Yardley, PA (US); Mingquan Wu, Princeton Junction, NJ (US); Kumar Ramaswamy, Princeton, NJ (US)

Correspondence Address: Robert D. Shedd, Patent Operations;THOMSON Licensing LLC, P.O. Box 5312, Princeton, NJ, 08543-5312, US

(21) Appl. No.: 12/803,969

(22) Filed: Jul. 9, 2010

Related U.S. Application Data
(60) Provisional application No. 61/271,138, filed on Jul. 17, 2009.

(51) Int. Cl. H04J 3/14

(52) U.S. Cl. 370/231

(57) ABSTRACT

Because packets dropped due to network congestion cannot reach the intended receiver whereas corrupted packets can still be received, the reception status of multiple packets is different for congested and non-congested paths. This difference reflects a spatial variation in the received data stream that is indicative of congestion. Network congestion detection is described that treats the reception status of sequences of multiple packets as patterns and converts the problem of congestion detection into a two-class pattern classification problem. A Support Vector Machine (SVM) classifier is trained to classify the reception status of sequences of packets as being indicative or not of network congestion. If network congestion is detected, congestion control measures can then be taken. Extensive simulations demonstrate high detection accuracy under different network parameters.

### CROSS REFERENCES

This application claims the benefit under 35 U.S.C. §119(e) of U.S. Provisional Application No. 61/271,138, filed Jul. 17, 2009, the entire contents of which are hereby incorporated by reference for all purposes into this application.

### FIELD OF THE INVENTION

The present invention generally relates to digital communications systems and methods and, more particularly, to packet communications systems and methods.

### BACKGROUND OF THE INVENTION

The Internet is a packet switched network that uses statistical multiplexing for link sharing. Link bandwidth is dynamically allocated to applications to improve link utilization. However, in order to allow networks to be easily inter-connected, complexity should be deployed at the end systems to simplify the core network.

The current core IP network is stateless and does not provide “on demand” link bandwidth allocation for each application. Applications send packets without knowing the current capacity of the end-to-end path. But packets will be dropped if capacity is exceeded. The transport Transmission Control Protocol (TCP) keeps trying to probe available bandwidth by increasing the sending rate until the bottleneck link of the path reaches its capacity. At this point, TCP slows down. When many applications share the same bottleneck link, it is necessary to fairly share the bandwidth among them.

To avoid network collapse, it becomes important for applications to be network friendly. TCP Friendly Rate Control (TFRC) has been proposed to allow applications to fairly share network resources even if they do not use TCP. New protocols such as SCTP and DCCP, among others, use similar mechanisms to prevent the network from collapsing.

Traditionally, TCP uses packet loss as an indication of network congestion, assuming an error-free, wired network environment. However, the proliferation of various wireless networks implies that many packets will be dropped due to transmission error instead of network buffer overflow, as would occur with network congestion. Thus, a packet loss based approach does not work well anymore.

The importance of distinguishing wireless loss from congestion loss has motivated various approaches, including some that require support from the core network. These include notification-based schemes: Explicit Congestion Notification (ECN), Explicit Transport Error Notification (ETEN); prioritization of packet dropping: traffic labeling; and additional network acknowledgement: last/first-hop acknowledgment. These approaches, however, are not end-to-end and require infrastructure changes, making them difficult to deploy.

Most existing end-to-end approaches rely on temporal variation—i.e. the end-to-end delay dynamics—to identify packet loss due to bottleneck queue overflow. Examples include TCP-Vegas, TCP-Westwood, and TCP-Veno. However, delay-based congestion avoidance is not encouraged.

Other end-system-only approaches use variations of end-to-end packet trip delays for congestion detection: the Round Trip Time (RTT) at the sender; the Relative One-way Trip Time (ROTT) at the receiver; the packet inter-arrival time at the receiver; or a combination of ROTT and packet loss rate. But such approaches, which are based on temporal variation, can be affected by network fluctuations and cross traffic and only perform well in limited scenarios. Moreover, recent measurement studies have shown little correlation between increased delay and congestion losses.

Based on the network behavior responding to load, Non-Congestion Packet Loss Detection (NCPLD) calculates a round-trip time (RTT) threshold. If network load is light, RTT should be less than this threshold, otherwise, RTT will be larger. NCPLD measures RTT at the sender and compares it with the calculated RTT threshold to determine whether or not a packet loss is caused by congestion.

In order to make continuous media applications based on User Datagram Protocol (UDP) share the network fairly with other applications, Tobe et al. describes an approach which uses the variations in one-way delay, called Relative One-way Trip Time (ROTT), to determine the current path status. (See Y. Tobe et al., “Achieving moderate fairness for udp flows by path-status classification,” 2000.) Packets lost with spike trains will be treated as wireless loss.

Assuming a wireless link is the last hop and the bottleneck, Biaz et al. describes a scheme which measures the packet inter-arrival time at the receiver. (See S. Biaz et al., “Discriminating congestion losses from wireless losses using inter-arrival times at the receiver,” IEEE Symposium ASSET '99, Richardson, Tex., USA, March 1999.) Without any loss, the packet inter-arrival time should be the transmission time of a single packet. If a packet is lost due to wireless error, its transmission time will cause a larger gap between two consecutively received packets. On the other hand, if a packet is lost due to congestion, the gap will be smaller than it should be. Also based on the Biaz scheme, the ZigZag scheme uses both ROTT and the number of packet losses to reflect the fact that more severe loss is associated with higher congestion, and with higher ROTT. (See S. Cen et al., “End-to-end differentiation of congestion and wireless losses,” IEEE/ACM Trans. Netw., vol. 11, no. 5, pp. 703-717, 2003.)

NewReno-FF (Flip Flop) is a scheme which estimates congestion using the average and variance of round trip time (RTT). Assuming that observed RTT varies much upon congestion losses and varies little upon wireless losses, NewReno-FF uses a flip flop filter to count the number of packets whose RTT exceeds a control limit. If the number is large, the network is congested.

Model-based inference uses a Bayesian approach and long-term average packet loss probability over the wireless link and the delay distribution conditioned on the type of packet loss to infer the cause of a short-term packet loss.

Liu et al. describes using loss pairs to measure the RTT of congestion loss and wireless loss and discovers that the RTT distribution of congestion loss is more compact and has a larger average, compared with that of wireless loss. (See J. Liu, I. Matta et al., “End-to-end inference of loss nature in a hybrid wired/wireless environment,” Proceedings of WiOpt '03: Modeling and Optimization in Mobile, Ad Hoc and Wireless Networks, 2003.) A Hidden Markov Model (HMM) with four states is used to model whether the connection is in a wireless loss state or a congestion loss state. However, this approach assumes that there is only one most congested point and that most packet delays and losses happen at this point. When the utilization of the bottleneck link is high, the classification accuracy is very low. Moreover, the burstiness of packet loss is challenging for the loss pair approach, which requires reception of one of the two packets sent back-to-back.

The Two-Phase Loss Differentiation Algorithm (TP-LDA) combines differentiation algorithms at the link and transport layers. The first phase uses ROTT based on Tobe et al. to detect congestion loss at the transport layer. The second phase uses a beacon loss rate to detect link layer collision.

All of the aforementioned mechanisms use temporal variations to differentiate congestion loss from wireless loss. Recent measurement studies, however, have shown that there is little correlation between increased delay and congestion losses.

Assuming that transport protocols do not tolerate corrupted packets, the Media Access Control (MAC) layer will drop a packet if its link layer checksum test fails. However, when a packet is corrupted during transmission, it is likely that there is still useful data in the received packet. If the header is intact, the corresponding TCP socket can be located. TCP HACK uses a separate checksum for the TCP header. If a corrupted packet passes the TCP header checksum test, it is not treated as indicative of congestion. However, when the error rate increases, the number of packets with corrupted headers will also increase.

Some applications, such as the transmission of speech, might be able to tolerate a certain degree of data corruption. Moreover, some transport protocols (e.g., UDP lite) are designed to allow the delivery of corrupted packets to applications. The applications can either use the corrupted packets for recovery or drop them and request retransmission.

### SUMMARY OF THE INVENTION

Methods and apparatus are disclosed for detecting network congestion in error-prone environments using a Support Vector Machine (SVM) based classifier.

In accordance with an aspect of the present invention, a method is disclosed. According to an exemplary embodiment, the method comprises receiving a group of packets from a digital data network, identifying packet loss in the group of packets, classifying the group of packets as being associated with at least one of network congestion and corruption by analyzing the group of packets using a classifier trained to classify groups of packets with packet loss based on a spatial variance between groups of packets with packet loss caused by network congestion and groups of packets with packet loss caused by corruption, and providing an indication of network congestion for a sender of the group of packets if the group of packets is classified as being associated with network congestion.

In accordance with another aspect of the present invention, a method is disclosed. According to an exemplary embodiment, the method comprises sending a group of packets to a digital data network, receiving an indication of packet loss in the group of packets, classifying the group of packets as being associated with at least one of network congestion and corruption by analyzing the group of packets using a classifier trained to classify groups of packets with packet loss based on a spatial variance between groups of packets with packet loss caused by network congestion and groups of packets with packet loss caused by corruption, and performing a congestion control action if the group of packets is classified as being associated with network congestion.

In accordance with another aspect of the present invention, an apparatus is disclosed. According to an exemplary embodiment, the apparatus comprises a communication module for receiving a group of packets from a digital data network, a reception status block for identifying packet loss in the group of packets, a classification module for classifying the group of packets as being associated with at least one of network congestion and corruption by analyzing the group of packets using a classifier trained to classify groups of packets with packet loss based on a spatial variance between groups of packets with packet loss caused by network congestion and groups of packets with packet loss caused by corruption, and a notification module for providing an indication of network congestion for a sender of the group of packets if the group of packets is classified as being associated with network congestion.

In accordance with another aspect of the present invention, an apparatus is disclosed. According to an exemplary embodiment, the apparatus comprises means for receiving a group of packets from a digital data network, means for identifying packet loss in the group of packets, means for classifying the group of packets as being associated with at least one of network congestion and corruption by analyzing the group of packets using a classifier trained to classify groups of packets with packet loss based on a spatial variance between groups of packets with packet loss caused by network congestion and groups of packets with packet loss caused by corruption, and means for providing an indication of network congestion for a sender of the group of packets if the group of packets is classified as being associated with network congestion.

### BRIEF DESCRIPTION OF THE DRAWINGS

Some embodiments of apparatus and/or methods in accordance with embodiments of the present invention are now described, by way of example only, and with reference to the accompanying figures in which:

FIG. 1 illustrates the classification of congestion loss and non-congestion loss based on the reception status of contiguous packets;

FIG. 2 shows a flowchart of an exemplary congestion detection method using Support Vector Machine (SVM) techniques;

FIG. 3 shows a flowchart of an exemplary congestion detection method using SVM in which the sender performs congestion/non-congestion loss classification;

FIG. 4 shows a block diagram of an exemplary receiver that performs the loss classification and notifies the sender;

FIG. 5 illustrates a two-state channel model for evaluating the performance of an exemplary classification method;

FIG. 6 shows the performance of an exemplary classification scheme with different random error rates (samplen=6, payload=500 bytes, alpha=1.06);

FIG. 7 shows the performance of the exemplary classification scheme with different burst error channels. (alpha=1.06, payload=500 bytes, samplen=6);

FIG. 8 shows the performance of the exemplary classification scheme with different payload size(random bit error rate=0.06%, alpha=1.06, samplen=6);

FIG. 9 shows the performance of the exemplary classification scheme with different payload size(alpha=1.06, E_{b}=0.25%, E_{g}=0, P₀₁=0.005%, P₁₀=0.04%, samplen=6);

FIG. 10 shows the performance of the exemplary classification scheme with different sample length (alpha=1.06, payload=200 bytes, E_{b}=0.25%, E_{g}=0, P₀₁=0.005%, P₁₀=0.04%);

FIG. 11 shows the performance of the exemplary classification scheme with different sample length (random bit error rate 0.06%, payload=500 bytes, alpha=1.06);

FIG. 12 shows the performance of the exemplary classification scheme with different alpha (samplen=6, random bit error rate=0.06%, payload=500 bytes);

FIG. 13 shows the performance of the exemplary classification scheme with different alpha (samplen=6, payload=500 bytes, E_{b}=0.25%, E_{g}=0, P₀₁=0.005%, P₁₀=0.04%);

FIG. 14 shows the performance of an exemplary classification scheme with a model that is trained using different error rates (alpha=1.06, payload=500 bytes, random bit error rate for training=0.05%);

FIG. 15 shows the performance of an exemplary classification scheme with a model that is trained using different error rates (alpha=1.06, payload=200 bytes, G/E channel for training: E_{b}=0.5%, E_{g}=0.01%, P₀₁=0.5%, P₁₀=4%);

FIG. 16 shows the performance of the exemplary classification scheme with different cross traffic (alpha=1.06, payload=500 bytes, random bit error rate=0.06%, samplen=6);

FIG. 17 shows the performance of the exemplary classification scheme with different cross traffic (alpha=1.06, payload=200 bytes, samplen=6, E_{b}=0.5%, E_{g}=0.01%, P₀₁=0.5%, P₁₀=4%);

FIG. 18 shows the performance of the exemplary classification scheme with packet header protection (alpha=1.06, payload=500 bytes, samplen=6);

FIG. 19 shows the performance of the exemplary classification scheme with packet header protection (alpha=1.06, payload=200 bytes, samplen=6);

### DETAILED DESCRIPTION

An end-to-end congestion detection scheme is disclosed that treats the reception status of multiple packets as patterns and converts the problem of congestion detection into a pattern classification problem. In an exemplary embodiment, an SVM-based classifier is used to classify samples of received packets into either a congested group or a non-congested group. Based on the fact that packets dropped due to congestion cannot reach the receiver whereas corrupted packets can still be received, we assume that if we deliver corrupted packets whose headers are correct, the reception status of multiple consecutive packets will be different for congested and non-congested paths. More specifically, it has been discovered that packet loss due to network congestion is bursty, whereas in an error-prone environment, loss due to packet header corruption tends to be random and will demonstrate less burstiness. The distribution of packet loss is thus different for congestion and non-congestion causes, thereby exhibiting a spatial variance. In an exemplary embodiment, this spatial variance is used to classify the cause of packet loss as either network congestion or a non-congestion cause such as wireless corruption.

Extensive simulation shows that embodiments described herein achieve high classification accuracy under different network parameters.

In view of the above, and as will be apparent from the detailed description, other embodiments and features are also possible and fall within the principles of the invention.

In order to be network friendly, a transport protocol should have a congestion control mechanism. This requires the transport protocol to detect when the network is overloaded and back off to avoid network collapse. Without explicit notification from the network, the end system must infer the current network status on an end-to-end basis. As discussed above, in error-prone environments, packets can be dropped not only because of congestion, but also because of packet corruption.

One difference between packets dropped due to congestion and packets with corruption is that the receiver has no chance of receiving dropped packets while it is still possible to receive corrupted packets. Corrupted packets, if received, do not indicate network congestion. Allowing the reception of corrupted packets thus reduces the number of packets incorrectly categorized as indicative of network congestion. But not all corrupted packets can be received. It is still possible that certain packets cannot be successfully received due to corruption of important packet header fields. Although different from the case of packets lost due to buffer overrun, as would occur in a congested network, a conventional receiver could not tell the difference.

It has been discovered that packet loss due to network congestion is bursty. On the other hand, in an error-prone environment, if packet header corruption is random, corruption loss will demonstrate less burstiness. Thus the distribution of packet loss will be different and we call this difference spatial variance, in contrast to temporal variance. In an exemplary embodiment, this spatial variance is used to classify the cause of packet loss as either network congestion or a non-congestion cause such as wireless corruption. The reception of corrupted packets provides spatial variety helpful in making the classification between congestion and non-congestion related loss.

With the ability to receive corrupted packets, an exemplary congestion control mechanism can obtain more information about the link status. For example, a lost packet among a series of corrupted packets should be treated differently from packets lost in a burst, because the first type of loss is likely caused by corruption. Therefore, instead of considering each packet loss independently, the congestion control mechanism takes into account the group of packets among which a packet loss occurs. Making use of the packet loss context, it is possible for the congestion control mechanism to detect congestion more accurately than with a purely packet-loss-based approach.

Consider the reception status S of a group of p contiguous packets and define S as:

S=R₁R₂R₃ . . . Rₚ,

where R₁ is the reception status of the i-th packet. “O” indicates that the packet is received correctly, “L” indicates that the packet is lost either due to header corruption or network congestion, and “E” indicates that the packet is corrupted. A goal is to find a function M such that given a reception status S, function M infers whether or not there is congestion:

$$M ( S ) = \{ \begin{matrix}- 1 & No congestion \\ 1 & Congestion\end{matrix}$$

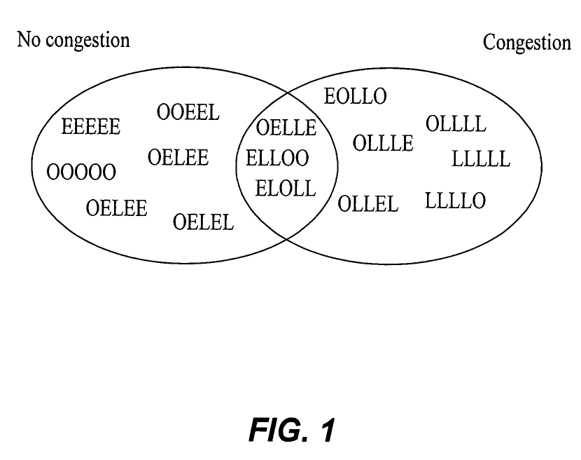

Instead of considering the reception status of each group of packets, or sample, independently, we can collect a number of samples, divided into two categories for corruption-only loss and corruption plus congestion loss respectively, as shown in FIG. 1. Given a new sample, we want to find a category for it. We thus treat congestion detection as a pattern classification problem. The classification is carried out by a classifier that has been trained to classify samples without explicit knowledge of their statistical properties: samples are considered similar if they are likely to be caused by the same condition. Once the classifier is trained, it can be used to predict a category for a new reception status of a group of packets.

### SVM-Based Classification

Support Vector Machines (SVMs) are methods for supervised classification. Given n training samples, each of which is represented as a vector x, and their respective labels—1 for positive samples (e.g., indicative of congestion) and −1 for negative samples (e.g., indicative of no congestion)—SVM can be used to learn a linear classifier:

f(x)=w^{T}x+b, (1)

where w is a weight vector and b is a bias.

When the training samples are not linearly separable, we can first map the samples to a higher dimensional feature space (Φ)(x):

f(x)=w^{T}(Φ)(x)+b, (2)

and then perform a linear classification in the new space.

The problem can be solved as the following optimization problem:

$${min}_{w , b , ξ} \frac{1}{2} {w}^{T} w + C {\sum }_{i = 1}^{n} {ξ}_{i} \\ subject to \begin{matrix}{y}_{i} ( {w}^{T} Φ ( {x}_{i} ) + b ) \geq 1 - {ξ}_{i} \\ {ξ}_{i} \geq 0 , i = 1 , … , n\end{matrix} \qquad ( 3 )$$

where yᵢ is the label of training sample vector xᵢ, ξᵢ is a slack variable allowing soft-margin classification, and C>0 is a constant that balances maximizing the margin and minimizing the amount of slack.

However, finding the correct mapping is not always easy. Without explicitly mapping each sample to the feature space, a kernel function can be used to directly calculate the inner product of two samples in the feature space:

K(xᵢ, xⱼ)=<Φ(xᵢ), Φ(xⱼ)> (4)

The optimization problem now becomes:

$${max}_{β} {\sum }_{i = 1}^{n} {β}_{i} - \frac{1}{2} {\sum }_{i = 1}^{n} {\sum }_{j = 1}^{n} {y}_{i} {y}_{j} {β}_{i} {β}_{j} K ( {x}_{i} , {x}_{j} ) \\ Subject to {\sum }_{i = 1}^{n} {y}_{i} {β}_{i} = 0 , 0 \leq {β}_{i} \leq C \qquad ( 5 )$$

In an exemplary embodiment, a radial basis function (RBF) is used as the kernel function:

K(xᵢ, xⱼ)=e^{-γ∥x}^{₁}^{=x}^{ⱼ}^{∥}^{²},γ>0. (6)

Selection of the parameter γ can be carried out as described, for example, in C. W. Hsu et al., “A Practical Guide to Support Vector Classification,” Nat'l Taiwan Univ., http://www.csie.ntu.edu.tw/˜cjlin, 2003.

Solving Eq. 5 yields a set of parameters β which are used to configure the classifier. The trained classifier carries out the following decision function:

$$sgn ( {\sum }_{i = 1}^{n} {y}_{i} {β}_{i} K ( {x}_{i} , x ) + b ) , \qquad ( 7 )$$

where the result indicates whether sample x is positive or negative.

It should be noted that the string representation of each sample has some limitations. For example, the patterns “LLLOO”, “OLLLO” and “OOLLL” look different but they should all be classified as indicative of congestion. Before training the SVM-based classifier, the training data should be in a format that can be easily used by the classifier. Typically, SVM works with vector data, each dimension of which represents a feature of the sample. For congestion detection, features that are most related to network congestion should be used.

Because a goal of an exemplary classifier is to classify packet loss types based on loss distribution, the sample vector representation should be focused on loss characteristics. In an environment with a relatively stable error rate, most of the reception patterns will be similar. The existence of congestion, however, will make a pattern different from most wireless-loss-only patterns. Firstly, the number of lost packets might increase. Moreover, either the burst size or the number of bursts might also increase, depending on whether or not the congestion loss is adjacent to a wireless loss. Thus, in an exemplary embodiment, the feature vector of each sample is represented as <nburst, maxburst*M, nloss>, where nburst is the number of burst losses of two or more packets, maxburst is the maximum burst length, and nloss is the total number of lost packets in the sample. Because congestion loss exhibits burstiness, it is preferable to give maxburst more weight, in which case M≧1. In an exemplary embodiment M=1.5. It has been found that using M=1.5 achieves better classification accuracy than M=1. In a further exemplary embodiment, the value of M is adjusted based on the reception status of neighboring packets. For example, for a given sample, M can be adjusted from 1.0 by adding 0.5 for each “O” and subtracting 0.5 for each “E” neighboring the largest burst in the sample.

In an exemplary embodiment, the total number of packets in each sample is preferably four to eight.

Failure to detect a corruption loss may result in the poor performance of a connection whereas failure to detect congestion may result in network collapse. Therefore, it is preferable to minimize the probability of undetected congestion, even at the cost of undetected corruption loss. In an exemplary embodiment, a conservative heuristic is adopted: if there is only packet loss and no packet corruption, it is treated by the classifier as network congestion. Alternatively, if there is only packet loss and no packet corruption, the determination that there is network congestion can be made without invoking the classifier. In such an embodiment, the classifier is invoked only when there are any corrupted packets in a sample. In yet another embodiment, if there are too many lost packets in a sample, the sample is treated as indicative of congestion loss. In an exemplary embodiment, if more than 75% of the packets in a sample are lost, it is treated as congestion loss.

### Illustrative Implementations

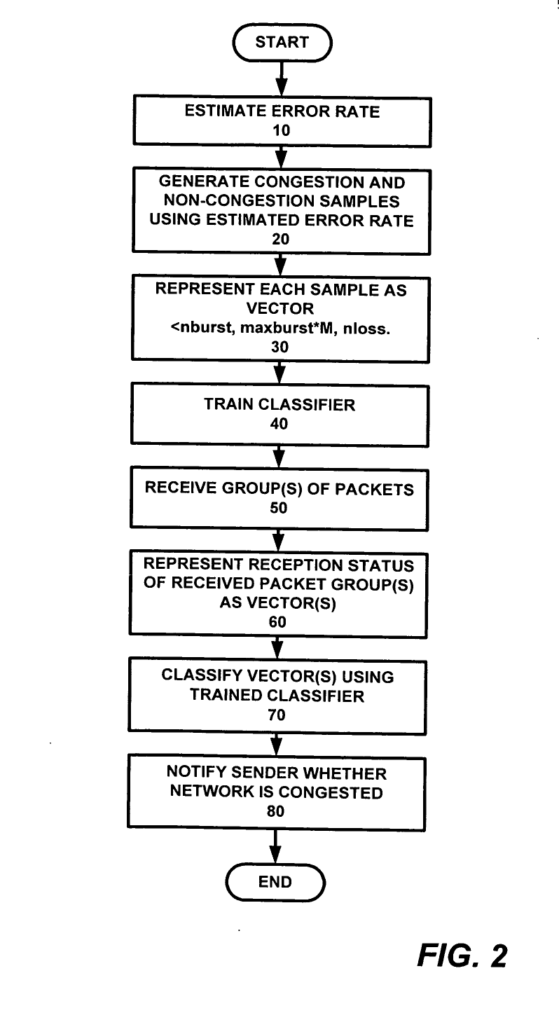

FIG. 2 shows the flow chart of an exemplary congestion detection method for implementation at a receiver.

First, at step 10, the error rate is estimated at the receiver, such as by sending a predetermined sequence of data from a sender and counting any errors at the receiver.

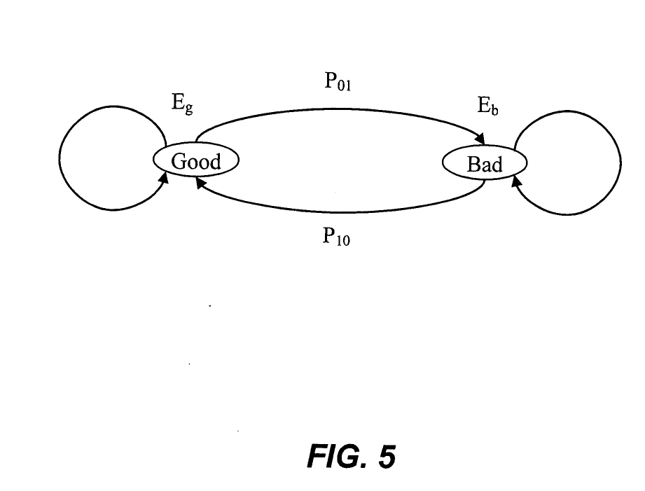

Then, at step 20, the estimated error rate is used in generating training samples for congestion and non-congestion conditions. In an exemplary embodiment, a random sequence of packets is generated and applied to a channel model, such as a Gilbert/Elliot model, described below with reference to FIG. 5, which introduces errors into the sequence. The parameters of the model are selected in accordance with the estimated error rate. The resultant sequence is then divided into groups of packets (e.g., eight consecutive packets in each group), and each group is labeled (−1) and used as a negative (non-congestion) training sample in the training procedure of step 40. To generate positive training samples, the random sequence of packets (or a new random sequence) is divided into groups of consecutive packets and a burst error is introduced into each group. The lengths of the burst errors introduced into the groups of packets follow a Pareto distribution. The remaining packets in each group are applied to the same channel model used to generate the negative samples. The resultant groups of packets are labeled (+1) and used as positive (congestion) training samples in the training procedure of step 40. In an exemplary embodiment, 400 positive and 400 negative training samples are used. The generation of training and simulated testing samples (for purposes of evaluation) is described below in greater detail.

At step 30, each training sample generated in step 20 is represented as a vector of the form <nburst, maxburst*M, nloss>. Thus, for an illustrative sample LEELLE, nburst=1, maxburst=2, and nloss=3, and given M=1.5, is represented by the vector <1, 3, 3>, with a label of −1 (no congestion).

At step 40, the classifier is then trained using the training samples, as described above.

At step 50, the receiver receives live packets, in the normal course of operation, which may or may not be corrupted. At step 60, the reception status of each group of contiguously received packets is determined and represented using the same vector format as the training samples, described above. At step 70, the trained classifier is then used to classify the new vector. At step 80, the classification result—whether or not there is congestion in the network—is then communicated to the sender. If there is congestion, the sender will take congestion control measures, described below.

It is contemplated that the process of FIG. 2 is repeated periodically. In an exemplary embodiment, steps 10-40, which involve training the classifier, can be carried out whenever the estimated error rate changes by more than a predetermined threshold. Steps 50-80, which involve using the trained classifier to detect congestion and notifying the sender if congestion is present, can be carried out for each group of packets received. In an alternative embodiment, steps 50-80 can be carried out for multiple groups of packets.

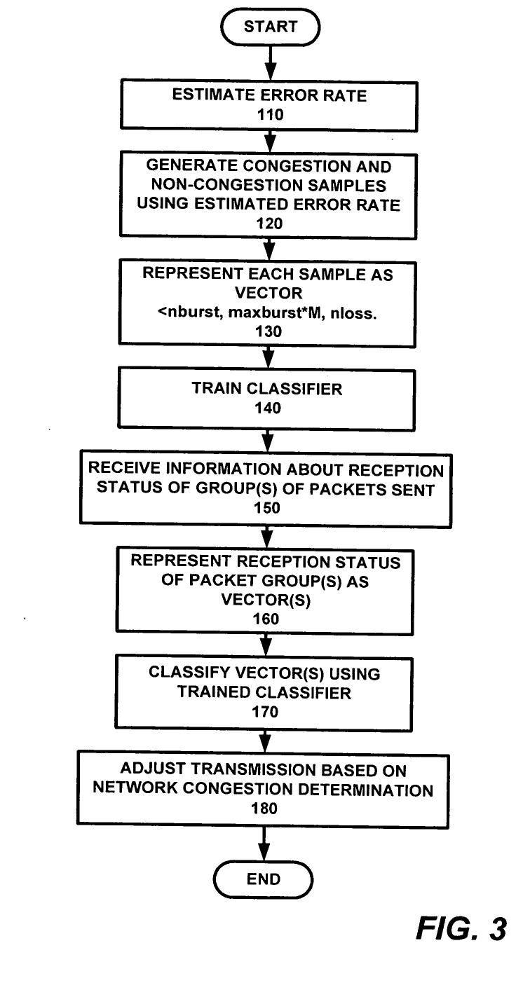

FIG. 3 shows the flow chart of an exemplary congestion detection method for implementation at a sender. At step 110, the receiver or a network element such as a router provides the sender with the reception status of packets sent from the sender, from which the sender can estimate the error rate. Alternatively, the receiver or network element can estimate the error rate, as described above, and communicate it to the sender. Then, at step 120, the estimated error rate is used to generate packet samples for congested and non-congested conditions, as described above. At step 130, each training sample generated in step 120 is represented as a vector of the form <nburst, maxburst*M, nloss>. At step 140, the classifier is then trained using the training samples.

At step 150, as the sender sends packets, which may or may not be corrupted upon reception, the sender determines the reception status of groups of contiguous packets based on acknowledgement information from the receiver. At step 160, the reception status of each group of contiguously received packets is represented using the same vector format as the training samples, described above. At step 170, the trained classifier is then used to classify the new vector. At step 180, the sender uses the classification result to adjust one or more sending parameters, such as the sending rate or congestion window size. (In TCP, the congestion window or TCP receive window, determines the number of bytes that can be outstanding at any time.) Thus, for example, if it is determined that the network is congested, the sender may decrease its sending rate or reduce its congestion window.

It is contemplated that the process of FIG. 3 is repeated periodically. In an exemplary embodiment, steps 110-140, which involve training the classifier, can be carried out whenever the estimated error rate changes by more than a predetermined threshold. Steps 150-180, which involve using the trained classifier to detect congestion and notifying the sender if congestion is present, can be carried out for each group of packets sent. In an alternative embodiment, steps 150-180 can be carried out for multiple groups of packets.

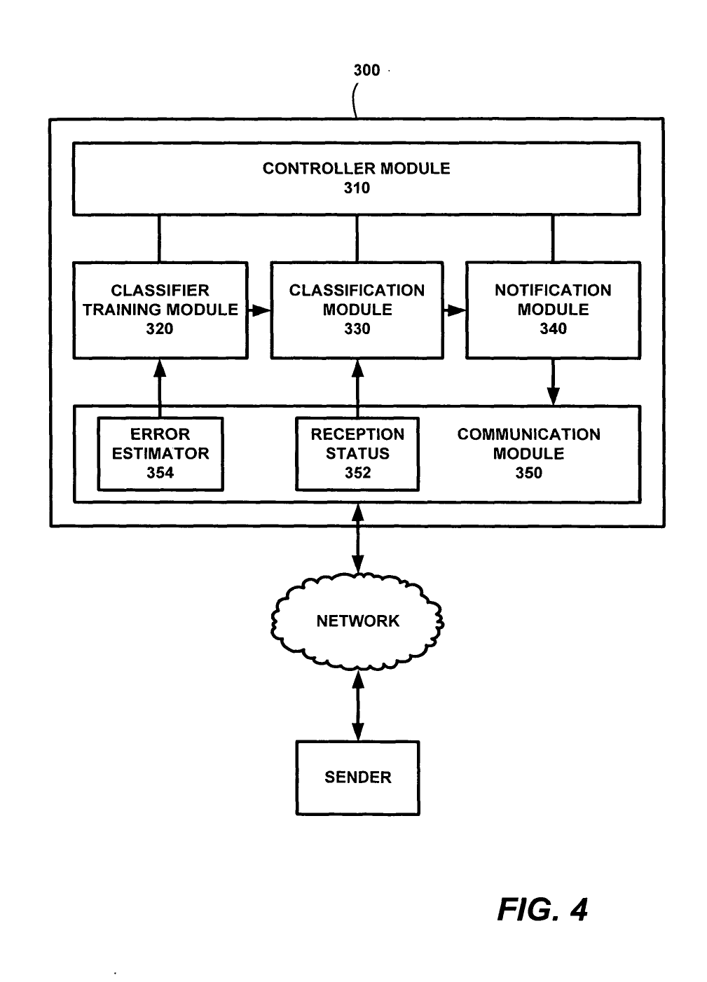

FIG. 4 shows a block diagram an exemplary embodiment of a receiver 300 which performs classification and notifies the sender. Receiver 300 includes controller module 310, classifier training module 320, classification module 330, notification module 340, and communication module 350.

Controller module 310 controls the other modules. Classifier training module 320 uses the estimated error rate to generate training data used to train an SVM classifier in module 330. Classification module 330 receives packet reception status information from communication module 350 and uses the trained SVM classifier to classify samples of multiple packets based on the reception status of the packets. The result of the classification—whether or not congestion is detected—is communicated to the sender using notification module 340. Communication module 350 is used for sending and receiving packets. Communication module 350 also includes a reception status block 352 for determining the reception status of packets received by receiver 300 and providing the reception status information to classification module 330. In an exemplary embodiment, communication module 350 also includes an error estimator 354 which provides classifier training module 320 with error rate estimates used in generating the aforementioned classifier training data.

### Evaluation

### Performance Metric

A goal of the above-described classifier is to predict whether there is congestion given the packet reception status samples of a connection. If there is no congestion, it is not necessary to trigger congestion control and thereby reduce the sending rate. However, if there is congestion, regardless of whether or not there is simultaneous wireless loss, the sending rate should be reduced in order to be network friendly.

A variety of metrics can be used to measure the performance of the classifier. Specifically, let the actual wireless loss event and congestion loss events be denoted as W and C, respectively. Let w and c denote the classification results for wireless loss and congestion loss, respectively. Therefore, P(w|W) and P(c|C) respectively denote the probabilities of correctly classifying wireless-loss-only and congestion-loss-only samples. In an exemplary embodiment, a sample is treated as indicative of congestion if there is packet loss but no corruption in the sample. Therefore, P(c|C) is 100%. P(c|W)=1−P(w|W) is the probability of congestion false alarm if wireless loss is misclassified as congestion loss. Moreover, when a TCP connection experiences both congestion and wireless loss, the sample is preferably classified as congestion. Another metric, P(c|W, C) is indicative of the accuracy of classifying mixed congestion and wireless loss. To guarantee network friendliness, we want to achieve high P(c|W, C), even at the cost of increased P(c|W) or reduced P(w|W).

### Modeling Wireless Error

We first use a uniform distribution error model to test the performance of the classifier. In this model, each bit has the same corruption probability.

A random bit error model does not reflect the bursty nature of many wireless channels. A model that can be used for a wireless channel is the Gilbert/Elliot model which uses a two-state Markov chain, as shown in FIG. 5. The transition probability from the good state to the bad state is P₀₁ and from the bad state to the good state is P₁₀. The bit error probability is E_{g} in the good state and E_{b} in the bad state.

Given a corrupted packet, if all its headers are intact, it can still be routed from hop to hop and its IP/port information can be used to find the corresponding socket. If the header is corrupted, however, it is not possible to correctly route the packet or locate a socket. Therefore, even if the reception of corrupted packets is allowed, header corruption can still cause packet losses. It is possible, however, to implement unequal packet protection so that more redundancy is used to protect packet headers and some errors can be corrected.

### Modeling Congestion Loss

Training the classifier requires a data set that represents packet loss patterns caused by network congestion. It has been shown that congestion loss for TCP is rather bursty, even within the same RTT. It has been found that the loss distribution follows a Pareto distribution. The distribution parameter, alpha, reflects the average length of the loss burst and can be estimated through experiments. Previous measurement work found values for alpha of 1.06 and 1.38.

In our measurement, we use a Pareto distribution to simulate packet loss due to network congestion. Let samplen be the number of packets in a sample (e.g., 5-8). Assuming a network without packet reordering, we use the reception status of every samplen consecutive packets as a sample. For each sample, we generate one burst of packet loss, the length of the burst following the Pareto distribution, thereby simulating a congestion event.

### Performance Measurement

### 1. Training And Testing

For each parameter set—including for example, error rate, sample length, packet payload size, RTT delay, and whether or not packet header protection is used—we first simulate 400 samples that are wireless loss only and another 400 samples that contain both congestion loss and wireless loss. We assume the same size for all packets. Each packet has a header size of 54 bytes, including headers of all layers. For a wireless-only sample, a packet is dropped only when any of its header is corrupted. For the combined wireless loss and congestion loss, a burst loss is simulated using a Pareto distribution, and then packets not dropped due to congestion will go through the wireless channel model. Corrupted packet headers will cause further wireless packet losses.

When the wireless error rate increases, many packets can be lost due to unrecoverable header corruption. In this case, congestion loss will not impact the patterns much. As described above, in a network friendly embodiment, if there are too many lost packets in a sample, the sample is treated as indicative of congestion loss. In an exemplary embodiment, if more than 75% of the packets in a sample are lost, it is treated as congestion loss.

As mentioned above, packet loss due to congestion is bursty. But if an error burst is long, header corruption can also cause burst loss of packets. Packets immediately before and after a congestion burst, however, will likely be received correctly, whereas packets surrounding an error burst more likely will be corrupted. So the patterns of “OLLO” and “ELLE” should be treated differently. Through experiments, we found that adjusting the maxburst factor M by adding 0.5 for each neighboring “0” and subtracting 0.5 for each neighboring “E” performs well.

The classifier is then trained using libsvm (see http://www.csie.ntu.edu.tw/˜cjlin/libsvm/) with a RBF kernel. Finally, we simulate 100 samples of wireless loss only to test P(c|W) and 100 samples of combined wireless and congestion loss to test P(c|W, C). For each parameter set, we repeat five times and show the minimum, maximum and average accuracy.

### 2. Error Rate

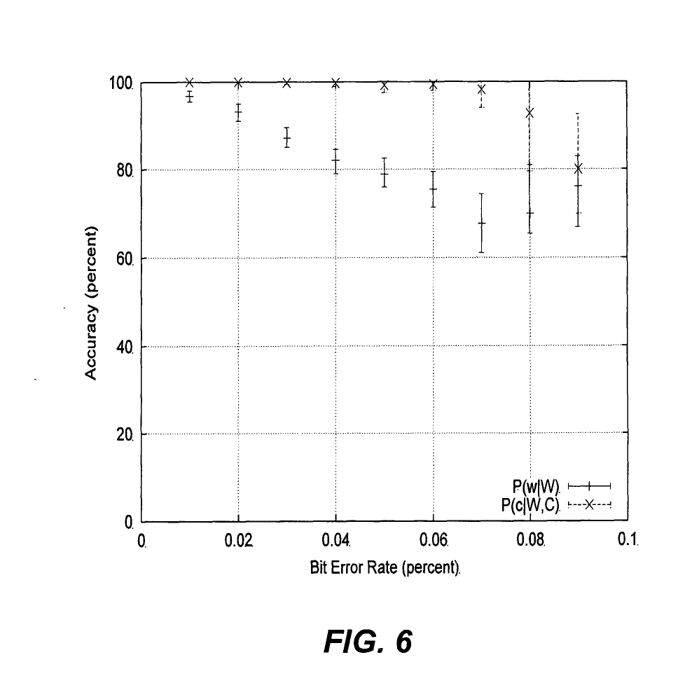

When the error rate increases, more packets will be dropped due to header corruption. FIG. 6 shows the classification accuracy of P(c|W) and P(c|W, C) as the random error rate increases. The illustrative data depicted in FIG. 3 was modeled with samplen=6, payload=500 bytes, and alpha=1.06. When the bit error rate is low, burst loss due to header corruption is rare. All burst loss is treated as congestion, so P(c|W, C) is high and the false alarm rate P(c|W) is low. When the error rate increases, burst corruption loss also increases. But the frequency is still much less than burst loss caused by congestion. So P(c|W, C) remains high, while P(c|W) increases due to the misclassification of burst corruption loss. When the error rate increases beyond a threshold, packet loss due to corruption becomes more frequent. This results in decreasing P(c|W). But some congestions are classified as wireless loss as shown by the decreasing P(c|W, C).

Classification accuracy was also tested under the Gilbert/Elliot channel model which exhibits bursty bit errors. Illustrative parameters for six channels are listed in Table 1. The channel parameters were modified to increase the average bit error rate.

TABLE 1

| channel | E_{b} | E_{g} | P₀₁ | P₁₀ | Avg Error |
|---|---|---|---|---|---|
| 1 | 0.001 | 1.0 e−5 | 0.0003125 | 0.0025 | 0.00012 |
| 2 | 0.001 | 0.0001 | 0.005 | 0.04 | 0.0002 |
| 3 | 0.0375 | 0 | 8.68 e−05 | 0.0087 | 0.00037 |
| 4 | 0.005 | 0.0001 | 0.005 | 0.04 | 0.00064 |
| 5 | 0.01 | 0.0001 | 0.005 | 0.04 | 0.0012 |
| 6 | 0.05 | 0.0001 | 0.005 | 0.04 | 0.0056 |

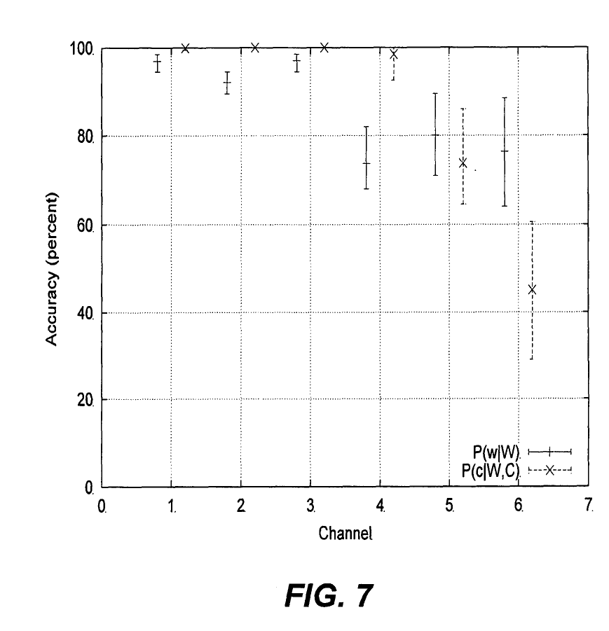

FIG. 7 shows the classification accuracy of the six different channels. P(c|W, C) is high and P(c|W) is low when error rate is low. Then P(c|W, C) decreases and P(c|W) increases as error rate increases. P(c|W) decreases when error rate is very high and many packets are dropped due to header corruption, but P(c|W, C) decreases.

### 3. Packet Length

Larger packets require longer transmission time than smaller packets and are thus more likely corrupted. To understand the impact of packet length on classification performance, we used different packet lengths to measure classification accuracy. For each packet, we set the packet header size to be 54 bytes.

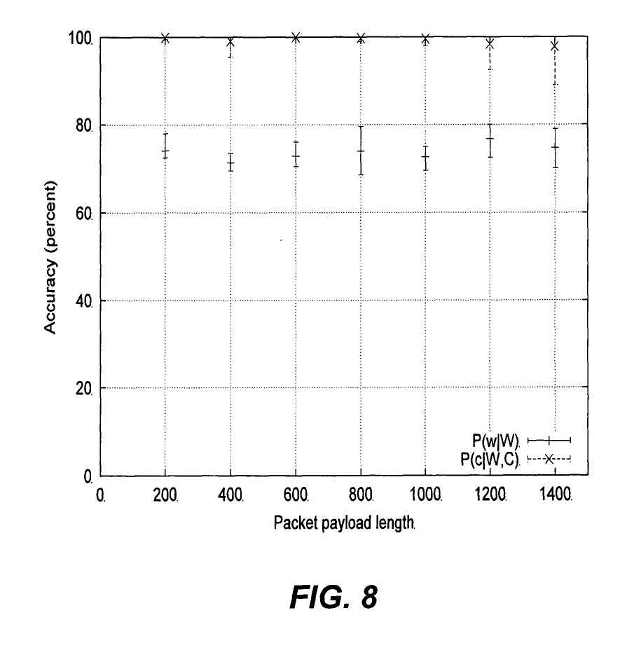

We first used a random error model with a bit error rate of 0.06%. If bit errors are uniformly distributed, the packet loss rate due to header corruption depends on packet header size, regardless of payload. As shown in FIG. 8, the average of both P(c|W) and P(c|W, C) remain relatively constant independent of payload size. When packet size increases, more packets will have corrupted payloads. This reduces the classification power of bursty loss if neighboring packets are corrupted. This is illustrated as the larger fluctuation of P(c|W, C) in the figure for packet payload sizes of 1,200 and 1,400.

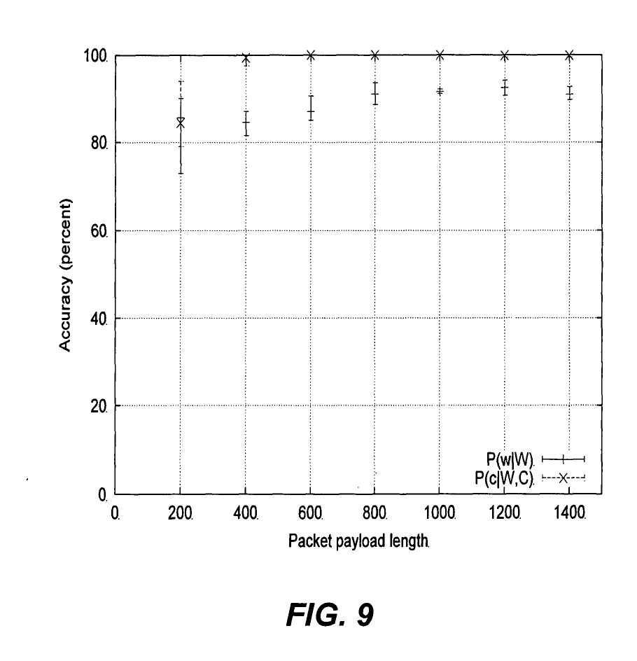

In an environment with bursty errors, packet loss due to header corruption will be affected by payload size. The larger the payload, the more likely an error burst will happen in the payload. Where all packets are assumed to have a fixed header length, packets with shorter payloads have higher probabilities of packet loss due to header corruption. As a result, increased wireless loss creates more noise for the classifier and causes more fluctuation of classification accuracy. This is shown in FIG. 9. P(c|W, C) of packets with 200 payload bytes is lower than that of larger packets. Moreover, the fluctuation of P(c|W) is also larger for small packets. As packet payload size increases, P(c|W, C) becomes higher and remains stable, and the fluctuation of P(c|W) also decreases.

### 4. Sample Length

The number of packets used in a sample affects the response time of the congestion control mechanism in case of network congestion. Using more packets in a sample will cause the congestion control mechanism to respond unnecessarily slowly if congestion can be detected with fewer packets. In order to be network friendly, we want to minimize the number of packets used in a sample. The approach of using any packet loss as a congestion indication is an extreme case that uses one packet in a sample. This has the shortest response time but due to the lack of context, it does not allow enough variety for loss pattern classification. The number of packets in a sample should also be enough to allow spatial variety so that patterns with congestion can be distinguished from patterns with only wireless loss. Moreover, short sample length implies more frequent sample prediction. For a given total number of packets, more classifications will be performed, increasing resource usage. Traditional TCP uses three duplicate acknowledgements to detect packet loss. This requires the reception status of at least four data packets. So we use four packets as the minimum sample length.

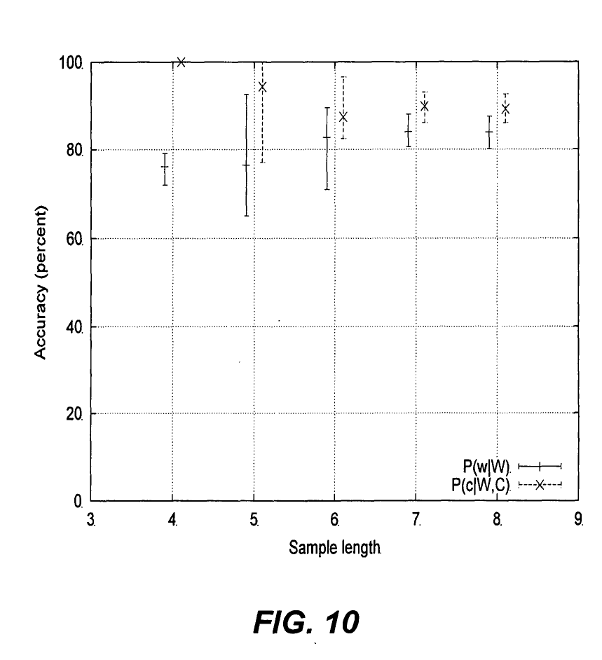

FIG. 10 shows the classification accuracy in a bursty error environment. As sample length increases, more variety is allowed so P(c|W) decreases. However, P(c(W, C) decreases. This is because putting more packets in a sample increases either nburst, maxburst or nloss of the feature vector, making congestion loss less distinguishable.

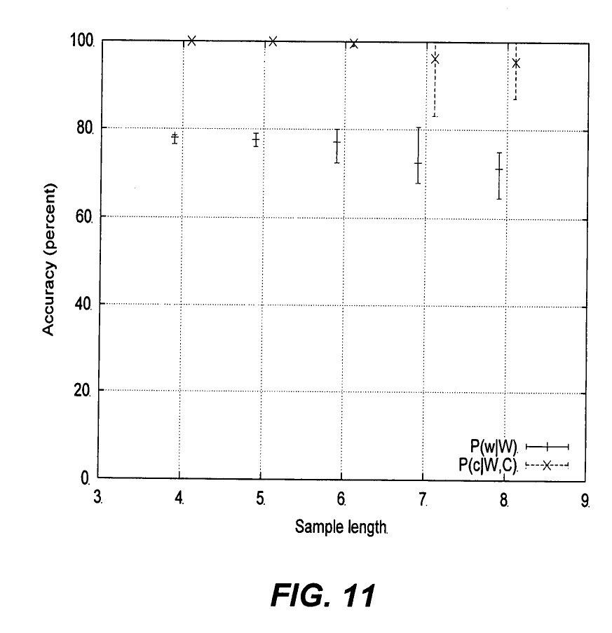

FIG. 11 shows the classification accuracy when bit errors are uniformly distributed. When we use more packets in a sample, more packets will be dropped due to header corruption, causing greater fluctuation of both P(c|W) and P(c|W, C).

### 5. Alpha

The parameter alpha reflects the expected burst length of congestion loss. It varies with end-to-end path status, cross traffic patterns, etc. As mentioned, previous measurement work found different values for alpha, namely, 1.06 and 1.38. In this test, we measure the classification accuracy with different values for alpha.

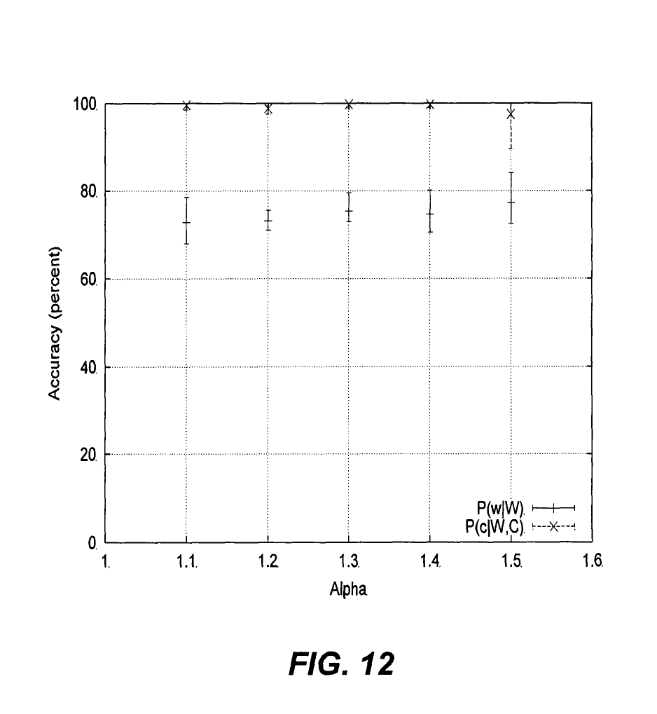

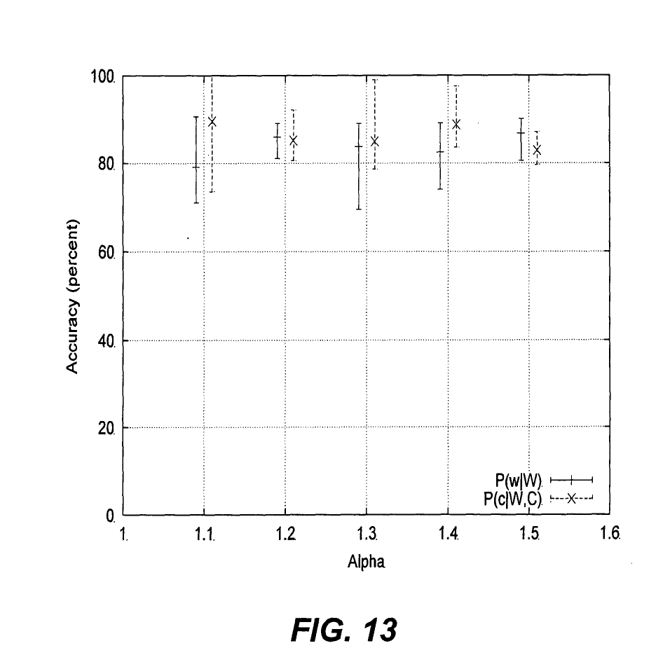

As shown in FIGS. 12 and 13, the classification performance does not change much when alpha changes. The reason is that alpha affects the expected value of burst loss length. The exemplary classifier, however, can perform classification with a burst loss length less than the expected value.

### 6. Different Error Rate For Training And Testing

Link error rate might not remain constant. But it may not be feasible or practical to measure the error rate in real time and train the classifier each time the error rate changes. Moreover, given a sample, we cannot easily find a classifier trained with the same error rate. It is preferable for the trained classifier to allow some fluctuation in error rate. In this measurement, we test how the exemplary classifier trained in one error environment performs in slightly different error environments.

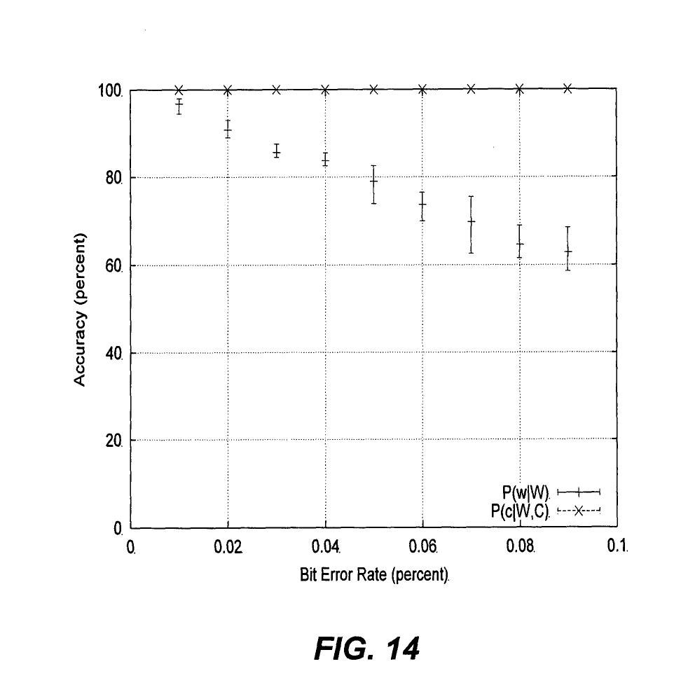

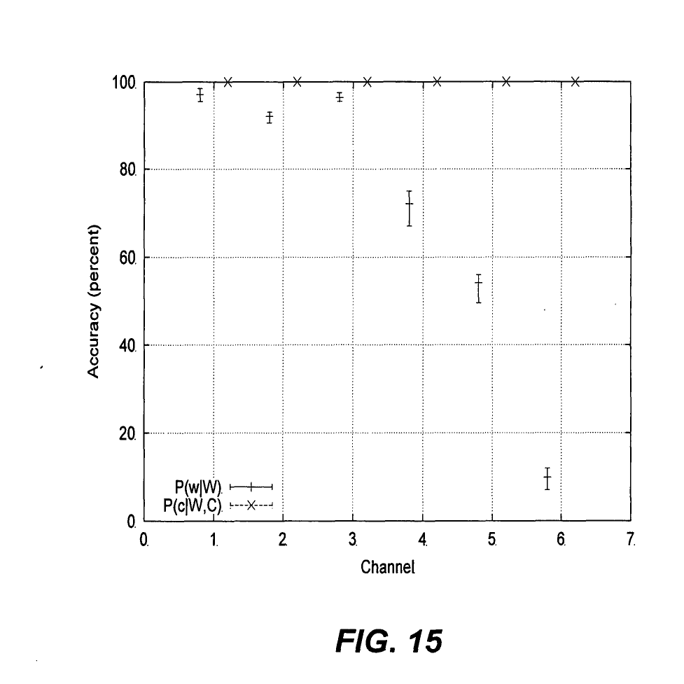

As FIGS. 14 and 15 show, if the actual error rate is lower than the error rate used for training, the classifier can still classify congestion loss and wireless loss with high accuracy. When actual error rate is larger, P(c|W, C) remains high, but P(c|W) increases. The reason is that if the actual error rate is higher than the error rate used for training, some wireless losses caused by increased error rate will be classified as congestion. However, if the error rate used for training is much higher than the actual error rate, more losses will be allowed in the non-congestion training samples and some congestion loss will be misclassified as wireless loss. (This is not shown in the graph). In order to be network friendly, we can choose a small error rate for training.

In an exemplary embodiment, a table of training models corresponding to different error patterns and error rates is created. The traffic is monitored periodically to estimate the current error pattern and error rates. Based thereon, a training model is chosen from the aforementioned table and used to train the classifier.

### 7. Cross Traffic

The statistical multiplexing nature of the Internet implies that the link is likely shared by multiple applications, either running on the same host or on different hosts. When training the exemplary classifier, however, we do not know how much cross traffic there will be in a real environment. It is preferable to train a classifier that works independently of cross traffic. In this test, we measure the impact on classification accuracy of cross traffic sharing the same link. Cross traffic that causes congestion is already reflected in the burstiness of TCP's congestion loss distribution. So we only consider cross traffic that shares the same wireless link.

For this test, when generating testing samples, cross traffic was randomly added. The training process was not changed. Although this is a simplified approach and does not consider the burstiness of cross traffic, this test can provide an indication of how cross traffic can affect the classifier's performance.

For simplicity, the cross traffic packets added have the same size as the TCP data packets. After collecting enough packets, we remove cross traffic packets from the samples for testing, because these packets will not be delivered to the TCP socket.

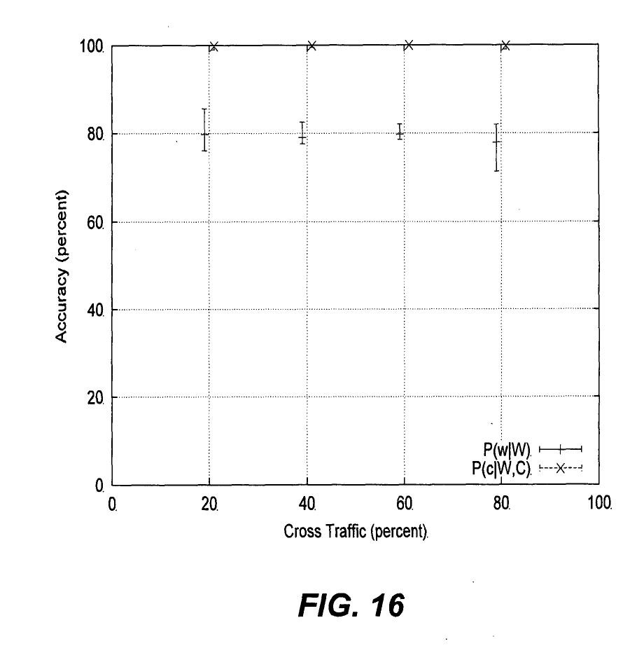

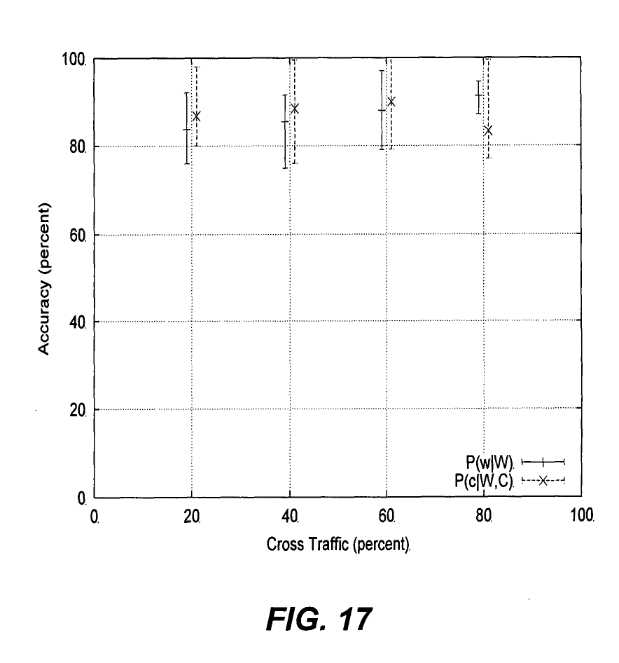

FIGS. 16 and 17 show the classifier's performance under different percentages of cross traffic. In a random error environment, all packets have the same probability of loss due to header corruption. Packets of cross traffic are not used by the classifier so the accuracy remains the same over different percentages of cross traffic. In a burst error environment, the randomly added cross traffic can share some of the burst errors. When cross traffic increases, the impact on an individual connection will decrease. This is shown as decreased P(c|W). However, P(c|W, C) remains stable.

### 8. Improving Classification Accuracy With Packet Header Protection

Because the performance of the classifier depends on the reception of corrupted packets, the more packets received, the more accurate the classifier will be. The importance of packet headers makes it reasonable to add redundancy for header protection, especially when the error rate increases.

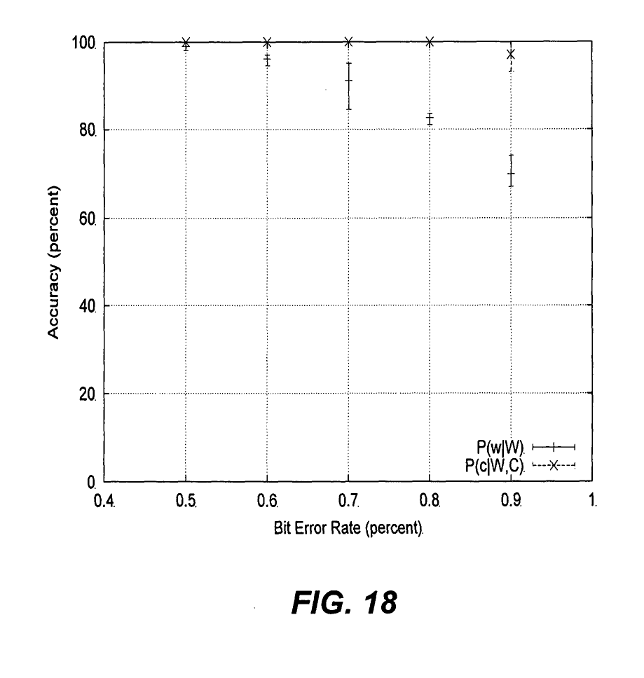

In order to illustrate the impact of header protection on classification accuracy, an additional ten bytes was used in each packet header, allowing recovery of up to five corrupted bytes. Under the error rates used in the above-described tests, almost all packet headers were recovered. In this test, the error rate was increased so that some packets could not be recovered. FIG. 18 shows the classification accuracy in a uniform bit error environment. Even at an error rate of 0.6%, P(c|W) is close to 0% and P(c|W, C) is very close to 100%.

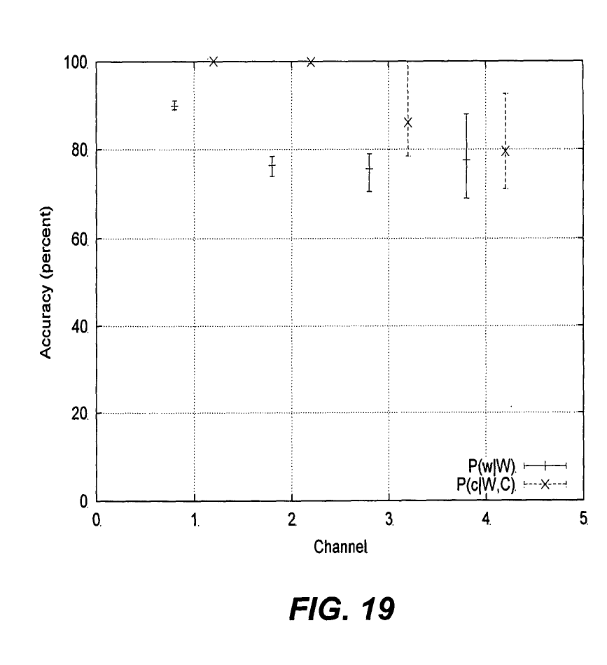

If bit errors are bursty but the overall error rate is low, header protection can recover many packets and the classification accuracy is high. The error rate in the bad state was increased to measure the impact of header protection on classification performance in an increased error environment. We used another three channels in addition to a previous one. The channel parameters are listed in Table 2. The classification performance is shown in FIG. 19. Header protection greatly increases the error tolerance of the classifier.

TABLE 2

| channel | E_{b} | E_{g} | P₀₁ | P₁₀ | Avg Error |
|---|---|---|---|---|---|
| 1 | 0.05 | 0.0001 | 0.005 | 0.04 | 0.0056 |
| 2 | 0.07 | 0.0001 | 0.005 | 0.04 | 0.00787 |
| 3 | 0.09 | 0.0001 | 0.005 | 0.04 | 0.01 |
| 4 | 0.11 | 0.0001 | 0.005 | 0.04 | 0.0123 |

An advantage of the disclosed congestion detection methods and apparatus is that they are independent of the number of bottleneck links along the end-to-end path, as long as the end systems observe burst loss behavior. However, in a network that is slightly congested, it is likely that a single packet will be dropped during a long period, especially if some queue management schemes are used. In the above description, congestions that cause burst losses were considered, because they are the most frequent loss patterns. When the network is slightly congested, existing approaches based on delay variations can be used.

In the above described experiments, we only consider bulk data transfer applications and thus there is always data to send. For interactive applications with limited data to send, we assume that the sending rate is limited by the application, not the congestion window. Moreover, the experiments addressed only end-to-end paths with one wireless link.

Both the training samples and testing samples have a fixed number of packets, ignoring inter-packet sending delay. In an actual implementation, it may be preferable to take packets that are sent in a burst as a sample. For example, TCP is bursty and several packets might be transmitted back-to-back. It is likely that packets transmitted closely together can be used more effectively to detect network conditions than packets transmitted with large inter-packet delay.

The exemplary embodiments described above rely on receiving corrupted packets. This is easily achievable if the last hop is the wireless link. If the wireless link is within the network, the wireless routers are preferably modified to forward corrupted packets. Moreover, the corrupted packets that help congestion classification might need to be corrected if data integrity is required.

In view of the above, the foregoing merely illustrates the principles of the invention and it will thus be appreciated that those skilled in the art will be able to devise numerous alternative arrangements which, although not explicitly described herein, embody the principles of the invention and are within its spirit and scope. For example, although illustrated in the context of separate functional elements, these functional elements may be embodied in one, or more, integrated circuits (ICs). Similarly, although shown as separate elements, some or all of the elements may be implemented in a stored-program-controlled processor, e.g., a digital signal processor or a general purpose processor, which executes associated software, e.g., corresponding to one, or more, steps, which software may be embodied in any of a variety of suitable storage media. Further, the principles of the invention are applicable to various types of wired and/or wireless communications systems, e.g., terrestrial broadcast, satellite, Wireless-Fidelity (Wi-Fi), cellular, etc. Indeed, the inventive concept is also applicable to stationary or mobile transmitters and receivers. It is therefore to be understood that numerous modifications may be made to the illustrative embodiments and that other arrangements may be devised without departing from the spirit and scope of the present invention.

What is claimed is:

1. A method comprising:
receiving a group of packets from a digital data network;
identifying packet loss in the group of packets;
classifying the group of packets as being associated with at least one of network congestion and corruption by analyzing the group of packets using a classifier trained to classify groups of packets with packet loss based on a spatial variance between groups of packets with packet loss caused by network congestion and groups of packets with packet loss caused by corruption; and
providing an indication of network congestion for a sender of the group of packets if the group of packets is classified as being associated with network congestion.

2. The method of claim 1, wherein the indication of network congestion is provided if the group of packets is classified as being associated with network congestion and corruption.

3. The method of claim 1 comprising:
estimating an error rate;
generating training samples based on the estimated error rate; and
training the classifier using the training samples.

4. The method of claim 1, wherein the classifier classifies the group of packets as being associated with congestion if the group of packets includes a burst of lost packets.

5. The method of claim 1, wherein the classifier classifies the group of packets as being associated with corruption if the group of packets includes a lost packet adjacent to a corrupted packet.

6. The method of claim 1, wherein each group of packets is represented by a vector including a number of lost packet bursts in the group, a maximum size of a lost packet burst in the group, and a number of lost packets in the group.

7. The method of claim 1, wherein the classifier is a Support Vector Machine classifier.

8. The method of claim 1, wherein the group of packets includes four to eight contiguously received packets.

9. A method comprising:
sending a group of packets to a digital data network;
receiving an indication of packet loss in the group of packets;
classifying the group of packets as being associated with at least one of network congestion and corruption by analyzing the group of packets using a classifier trained to classify groups of packets with packet loss based on a spatial variance between groups of packets with packet loss caused by network congestion and groups of packets with packet loss caused by corruption; and
performing a congestion control action if the group of packets is classified as being associated with network congestion.

10. The method of claim 9, wherein the congestion control action is performed if the group of packets is classified as being associated with network congestion and corruption.

11. The method of claim 9 comprising:
estimating an error rate;
generating training samples based on the estimated error rate; and
training the classifier using the training samples.

12. The method of claim 9, wherein the classifier classifies the group of packets as being associated with congestion if the group of packets includes a burst of lost packets.

13. The method of claim 9, wherein the classifier classifies the group of packets as being associated with corruption if the group of packets includes a lost packet adjacent to a corrupted packet.

14. The method of claim 9, wherein each group of packets is represented by a vector including a number of lost packet bursts in the group, a maximum size of a lost packet burst in the group, and a number of lost packets in the group.

15. The method of claim 9, wherein the classifier is a Support Vector Machine classifier.

16. The method of claim 9, wherein the group of packets includes four to eight contiguously received packets.

17. The method of claim 9, wherein performing a congestion control action includes at least one of reducing a sending rate and reducing a congestion window.

18. Apparatus comprising:
means for receiving a group of packets from a digital data network;
means for identifying packet loss in the group of packets;
means for classifying the group of packets as being associated with at least one of network congestion and corruption by analyzing the group of packets using a classifier trained to classify groups of packets with packet loss based on a spatial variance between groups of packets with packet loss caused by network congestion and groups of packets with packet loss caused by corruption; and
means for providing an indication of network congestion for a sender of the group of packets if the group of packets is classified as being associated with network congestion.

19. The apparatus of claim 18 comprising:
means for estimating an error rate;
means for generating training samples based on the estimated error rate; and
means for training the classifier using the training samples.

20. The apparatus of claim 18, wherein each group of packets is represented by a vector including a number of lost packet bursts in the group, a maximum size of a lost packet burst in the group, and a number of lost packets in the group.

21. The apparatus of claim 18, wherein the classifier is a Support Vector Machine classifier.

22. Apparatus comprising:
a communication module for receiving a group of packets from a digital data network;
a reception status block for identifying packet loss in the group of packets;
a classification module for classifying the group of packets as being associated with at least one of network congestion and corruption by analyzing the group of packets using a classifier trained to classify groups of packets with packet loss based on a spatial variance between groups of packets with packet loss caused by network congestion and groups of packets with packet loss caused by corruption; and
a notification module for providing an indication of network congestion for a sender of the group of packets if the group of packets is classified as being associated with network congestion.

23. The apparatus of claim 22 comprising:
an error estimator for estimating an error rate; and
a classifier training module for generating training samples based on the estimated error rate and for training the classifier using the training samples.

24. The apparatus of claim 22, wherein each group of packets is represented by a vector including a number of lost packet bursts in the group, a maximum size of a lost packet burst in the group, and a number of lost packets in the group.

25. The apparatus of claim 22, wherein the classifier is a Support Vector Machine classifier.
